(19) United States
(12) Patent Application Publication
(10) Pub. No.: US 2013/0201400 A1
(43) Pub. Date: Aug. 8, 2013

(54) COMMUNICATION TERMINAL AND WARNING INFORMATION RETRIEVAL METHOD

(71) Applicants: Makoto Sasaki, Chiyoda-ku (JP); Takeshi Higuchi, Chiyoda-ku (JP); Hiroki Shikama, Chiyoda-ku (JP)

(72) Inventors: Makoto Sasaki, Chiyoda-ku (JP); Takeshi Higuchi, Chiyoda-ku (JP); Hiroki Shikama, Chiyoda-ku (JP)

(73) Assignee: NTT DOCOMO,INC., Tokyo (JP)

(21) Appl. No.: 13/880,188

(22) PCT Filed: Jun. 27, 2012
(86) PCT No.: PCT/JP2012/066420

§ 371 Date: Apr. 18, 2013

(30) Foreign Application Priority Data
Jul. 11, 2011 (JP) 2011-153293

(51) Int. Cl. H04N 5/445

(52) U.S. Cl. CPC H04N 5/445
USPC 348/563

(57) ABSTRACT

A communication terminal includes a receiver that receives a one-segment signal from a broadcasting station among plural broadcasting stations that provide terrestrial digital broadcasting, an output unit that outputs the one-segment signal received by the receiver to a user; a channel search unit that searches for a specific broadcasting station that transmits the one-segment signal including an auxiliary information signal which is likely to include warning information, among the one-segment signals which are transmitted from the corresponding broadcasting stations, and a determination unit that determines, subsequent to termination of viewing with respect to the broadcasting station which is selected by the user, whether the auxiliary information signal included in the one-segment signal received from the specific broadcasting station by the receiver includes the warning information. When the auxiliary information signal includes the warning information, the output unit outputs the warning information to the user.

### TECHNICAL FIELD

The present invention relates to a communication terminal and a warning information retrieval method.

### BACKGROUND ART

As terrestrial digital broadcasting for a mobile terminal, so-called “One Seg” services have been provided. Each broadcasting station transmits its own broadcasting signals by using frequency resources or channels including thirteen segments. One of the thirteen segments is used for mobile terminals. In general, a broadcasting signal of one segment (one-segment signal), which is utilized for the One Seg, includes a transmission data representing audio and video; a control signal (Transmission and Multiplexing Configuration Control: TMCC); a pilot signal (Scattered Pilot: SP); and an auxiliary information signal for future expansion (Auxiliary Channel: AC). Currently, it is being considered to broadcast warning information such as an earthquake ground motion warning by using the AC signal. This point is described in Patent Document 1.

### Related Art Document

### [Patent Document]

Japanese Unexamined Patent Publication No. 2010-239334 (e.g., paragraph [0004])

### SUMMARY OF THE INVENTION

### Problem to be Solved by the Invention

In general, there are many broadcasting stations that perform the terrestrial digital broadcasting, and channels or frequency resources are allocated to each of the broadcasting stations. It is not mandatory for each of the broadcasting stations to broadcast the warning information by the AC signal when the one-segment signal is to be transmitted. Namely, it is expected that some broadcasting stations transmit the warning information by the AC signal, while the other broadcasting stations do not transmit such an AC signal. It is not known information for a user as to whether the broadcasting station is performing the operation to include the warning information in the AC signal. Accordingly, a problem of concern is that a user viewing a program of a broadcasting station, which is not performing the operation to include the warning information in the AC signal, may not find the warning information quickly.

An object of the present information is to reduce likelihood of a user to miss warning information, for a case where one-segment broadcasting of the terrestrial digital broadcasting is provided by plural broadcasting stations.

### Means for Solving the Problem

A communication terminal according to one embodiment is a communication terminal including a receiver that receives a one-segment signal from a broadcasting station among plural broadcasting stations that provide terrestrial digital broadcasting; an output unit that outputs the one-segment signal received by the receiver to a user; a channel search unit that searches for a specific broadcasting station that transmits the one-segment signal including an auxiliary information signal which is likely to include warning information, among the one-segment signals which are transmitted from the corresponding broadcasting stations; and a determination unit that determines, subsequent to termination of viewing with respect to the broadcasting station which is selected by the user, whether the auxiliary information signal included in the one-segment signal received from the specific broadcasting station by the receiver includes the warning information, wherein, when the auxiliary information signal includes the warning information, the output unit outputs the warning information to the user.

### Effect of the Present Invention

According to one embodiment, it is possible to reduce the likelihood of the user to miss the warning information when the one-segment broadcasting of the terrestrial digital television broadcasting is provided by the plural broadcasting stations.

### BRIEF DESCRIPTION OF THE DRAWINGS

FIG. 1 is a schematic diagram of a communication system that can be used in an embodiment;

FIG. 2 is a functional block diagram of a communication terminal in a first embodiment;

FIG. 3 is a flowchart showing an example of operations in the first embodiment;

FIG. 4 is a functional block diagram of the communication terminal in a second embodiment;

FIG. 5 is a flowchart showing an example of operations in the second embodiment;

FIG. 6 is a functional block diagram of the communication terminal in a third embodiment; and

FIG. 7 is a flowchart showing an example of operations in the third embodiment.

### EMBODIMENTS FOR CARRYING OUT THE INVENTION

According to an embodiment, even if a user selects a first broadcasting station that is not performing an operation to include warning information in an AC signal, a communication terminal automatically selects a second broadcasting station that is performing such an operation, then subsequent to termination of viewing a program, the communication terminal monitors the AC signal from the second broadcasting station, and the communication terminal quickly indicates the warning information to the user when the warning information is detected. In this manner, the likelihood of the user to miss the warning information can be significantly reduced.

Hereinafter, the embodiment is explained while referring to the accompanying drawings. In the drawings, the same reference numerals or the same reference symbols are attached to similar elements. The embodiment is explained from the following perspectives.

1. Communication System

2. First Embodiment

2.1 Communication Terminal

2.2 Example of Operations

3. Second Embodiment

3.1 Communication Terminal

3.2 Example of Operations

4. Third Embodiment

4.1 Communication Terminal

4.2 Example of Operations

### Embodiment

### <1. Communication System>

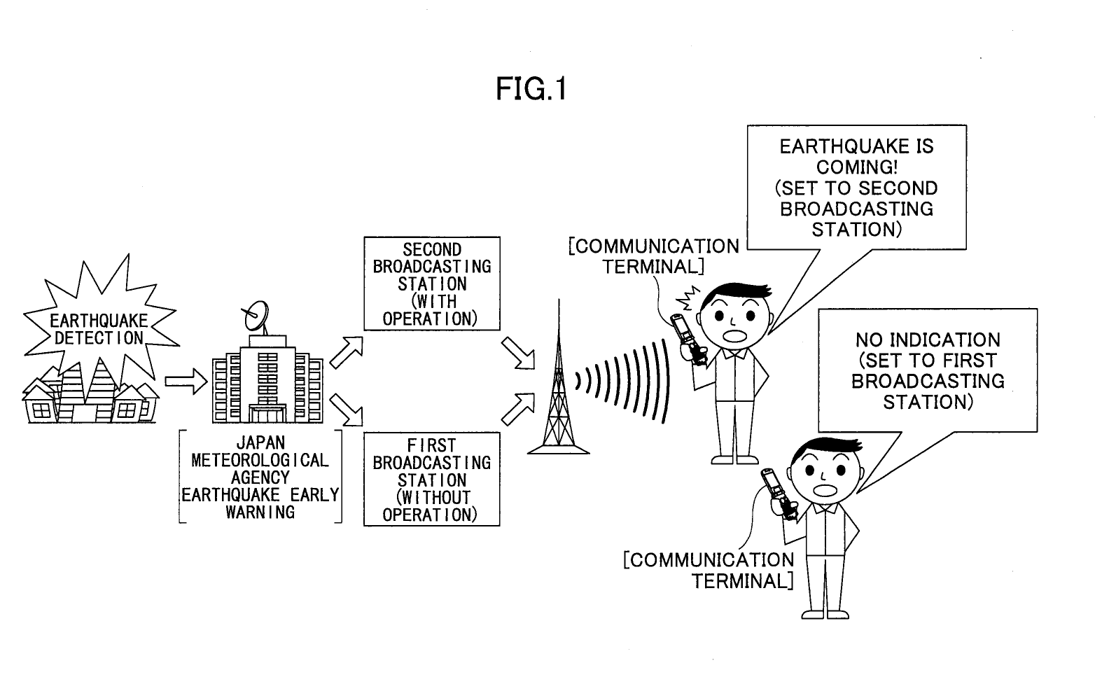

FIG. 1 shows a schematic diagram of a communication system that can be used in the embodiment. In FIG. 1, entities which are especially related to the embodiment are shown, among the various nodes, elements, and processing units included in the system. As shown in the figure, when a state of emergency such as an earthquake occurs, the Japan Meteorological Agency transmits information of the Earthquake Early Warning to plural broadcasting stations. For simplicity of the illustration, only two broadcasting stations, which are a first broadcasting station and a second broadcasting station, are depicted. Actually, there are many broadcasting stations. Not only the Japan Meteorological Agency, but an organization or an agency having certain authority, such as a local government, may transmit information. Further, not only the Earthquake Early Warning, but any warning information that prompts warning may be transmitted. For example, information such as tsunami warning, tidal wave warning, flood warning, and volcanic phenomena warning may be transmitted. Additionally, not only the information attributable to natural disaster, but also information attributable to a man-made disaster such as an international dispute may be transmitted.

The first broadcasting station and the second broadcasting station are broadcasting stations which perform terrestrial digital broadcasting. The first broadcasting station and the second broadcasting station provide their own programs by utilizing channels and frequency resources which are assigned to them. Especially, each of the broadcasting stations provides one-segment broadcasting by using one of the thirteen segments. A broadcasting signal (one-segment signal) for the one-segment broadcasting includes transmission data for audio and video, control information (TMCC), a pilot signal (SP), and an auxiliary information signal for future expansion (Auxiliary Channel: AC). The first broadcasting station is a broadcasting station that is not performing an operation to include warning information such as the Earthquake Early Warning in the AC signal in the one-segment signal. Whereas, the second broadcasting station is a broadcasting station that performs the operation to include the warning information such as the Earthquake Early Warning in the AC signal in the one-segment signal.

The one-segment signal, which is transmitted by the corresponding broadcasting station, is wirelessly transmitted to a user in a predetermined area. The correspondence between the broadcasting station and the channels (frequencies) utilized by the broadcasting station is defined in advance for each of areas. That area corresponds to the “predetermined area.” The user's communication terminal, which selects the first broadcasting station, receives the one-segment signal from the first broadcasting station. Since the first broadcasting station is not performing the operation to include the warning information in the AC signal, the user who receives the one-segment signal from the first broadcasting station does not quickly notice the existence of the warning information. Since the second broadcasting station is performing the operation to include the warning information in the AC signal, the user who receives the one-segment signal from the second broadcasting station can quickly notice the existence of the warning information. According to the embodiment, the user can properly receive the warning information, regardless of the broadcasting station selected by the user.

Hereinafter, the embodiment of the present invention is further explained from perspectives of three embodiments. These embodiments may be independently utilized, or two or more embodiments among these embodiments may be combined.

<2. First Embodiment>

<<2.1 Communication Terminal>>

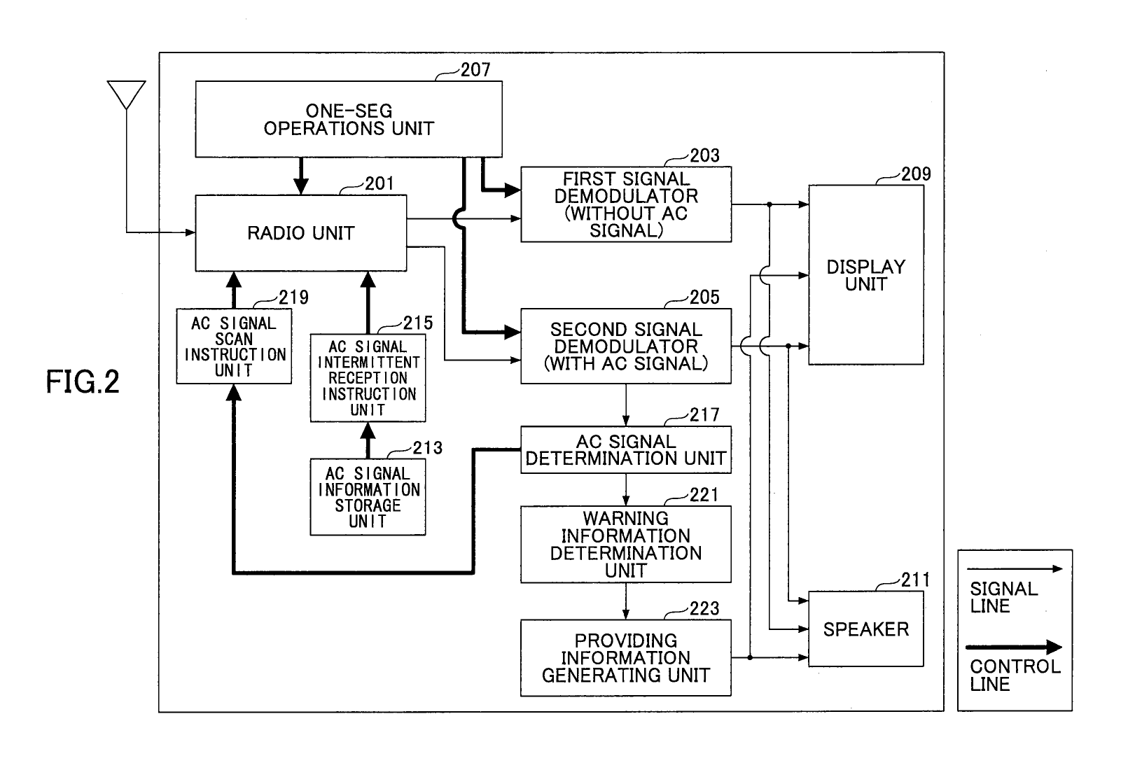

FIG. 2 shows a functional block diagram of a communication terminal in a first embodiment that can be used in the communication system shown in FIG.

1. FIG. 2 shows entities which are especially related to the embodiment, among various processing units and functional units included in the communication terminal. The communication terminal may be any suitable device that can receive the terrestrial digital broadcasting. The communication terminal is, specifically, user equipment, a mobile telephone, an information terminal, a high-performance mobile telephone, a smart phone, a tablet computer, a personal digital assistant, a mobile personal computer, a palmtop computer, a laptop computer, a desktop computer, or the like. However, the communication terminal is not limited to these. The communication terminal includes at least a radio unit 201; a first signal demodulator 203; a second signal demodulator 205; a one-seg operations unit 207; a display unit 209; a speaker 211; an AC signal information storage unit 213; an AC signal intermittent reception instruction unit 215; an AC signal determination unit 217; an AC signal scan instruction unit 219; a warning information determination unit 221; and a providing information generating unit 223.

The radio unit 201 receives a broadcasting signal of the terrestrial digital broadcasting, and the radio unit 201 converts it into a baseband signal. Specifically, the radio unit 201 receives a signal of one-segment broadcasting (the one-segment signal) which is transmitted by an orthogonal frequency division multiplexing (ODFM) method. The radio unit 201 includes a frequency filter, an amplifier, and a functional unit such as a frequency convertor, though they are not shown for simplicity of the illustration.

The first signal demodulator 203 demodulates and decodes the one-segment signal received from the first broadcasting station. The first broadcasting station is the broadcasting station that does not perform the operation to include the warning information such as the Earthquake Early Warning in the AC signal of the one-segment signal.

The second signal demodulator 205 demodulates and decodes the one-segment signal received from the second broadcasting station. Unlike the first broadcasting station, the second broadcasting station is the broadcasting station that performs the operation to include the warning information such as the Earthquake Early Warning in the AC signal in the one-segment signal.

For convenience of the illustration, the signal demodulators are only shown for the two broadcasting stations. However, there may be signal demodulators for any numbers of broadcasting stations. For the case of the example shown in the figure, it is assumed that signals from one or more broadcasting stations which do not perform the operation to include the warning information in the AC signal are processed by the first signal demodulator 203, and that signals from one or more broadcasting stations which perform such an operation are processed by the second demodulator 205.

The one-seg operations unit 207 is a user interface that enables operations for one-seg services. The user can perform, by the one-seg operations unit 207, activation and termination (ON/OFF) of the function to receive the one-seg broadcasting, and selection of the broadcasting station, for example. Typically, the one-seg operations unit 207 includes a selectable button. However, any mechanical interfaces, such as a keyboard, a mouse, or a trackball, may be included. Further, the one-seg operations unit 207 may function as an audio input interface, such as a microphone, so that an operation announced by the user can be executed. In the embodiment, the one-seg operations unit 207 records history of the broadcasting stations selected by the user, the channel of the currently selected broadcasting station, and the channel of the broadcasting station which was selected immediately prior to turning off the one-seg function.

The display unit 209 is a visual interface that visually outputs information to the user. Specifically, the display unit 209 may be a display, a control panel including a keypad, a cathode ray tube (CRT), a liquid crystal display (LCD), an organic electro-luminescence panel, or a touch screen, for example. However, the display unit 209 is not limited to these. In the embodiment, the display unit 209 is covered with a touch-sensitive transparent panel, and thereby the display unit 209 can detect motion of the user's finger to control the operation of the communication terminal. The separation between the display unit 209 and the one-seg operations unit 207 is not strict. Regarding operations for the One Seg, both the display unit 209 and the one-seg operations unit 207 function as the user interface for the user to input and output information.

The speaker 211 is an audio interface that outputs information to the user by sound. Typically, the speaker 211 outputs the sound included in the one-segment signal. However, sound for guidance, which is for guiding an operating method and the like, may be output depending on necessity.

The AC signal information storage unit 213 stores information regarding the AC signal. Specifically, the information regarding the AC signal may be information indicating which broadcasting stations are performing the operation to include the warning information in the AC signal, or information for obtaining the AC signal (e.g., a frame configuration of the one-segment signal, or timing for the broadcasting station to intermittently transmit the AC signals), for example. However, the information regarding the AC signal is not limited to these. As described later, when the broadcasting station which is selected by the user is not performing the operation to include the warning information in the AC signal, the communication terminal finds out the broadcasting station which is performing such an operation, and the communication terminal saves that information in the AC signal information storage unit.

Subsequent to termination of viewing the one-segment broadcasting by the user, the AC signal intermittent reception instruction unit 215 commands the radio unit 201, so that one-segment signals from a specific broadcasting station can be intermittently received and the AC signals can be extracted from a portion of the received one-segment signals. In principle, the specific broadcasting station is a broadcasting station that is performing the operation to include the warning information in the AC signal. However, when such a broadcasting station is unknown, the specific broadcasting station is the broadcasting station which is lastly selected by the user (the broadcasting station which was selected immediately prior to the termination of viewing). Technically, the one-segment signals may be always received. However, from a perspective of the battery saving, it is desirable that it activates at the timing where the AC signal is included, and that it conserves the battery energy during other time intervals.

The AC signal determination unit 217 determines whether the AC signal is suitably received from the broadcasting station that performs the operation to include the warning information in the AC signal. For the case of the current example, the first broadcasting station does not perform such an operation, but the second broadcasting station performs such an operation. Accordingly, the one-segment signal decoded by the first signal demodulator 203 is not subject to the determination by the AC signal determination unit 217. The one-segment signal decoded by the second signal demodulator 203 is the subject of the determination by the AC signal determination unit 217. The determination may be made by any suitable criterion as to whether the AC signal is suitably received from the broadcasting station which performs the operation to include the warning information in the AC signal. As an example, the determination may be made that the AC signal is not suitably received, when such an AC signal is not received for greater than or equal to a constant time period. When the determination is made that the AC signal is not suitably received, the AC signal determination unit 217 reports to the AC signal scan instruction unit 219 that searching (scanning or retrieving) for the channel may be started.

By cooperating with the radio unit 201, the AC signal scan instruction unit 219 finds or detects the broadcasting station that performs the operation to include the warning information in the AC signal, among the plural broadcasting stations that perform the one-segment broadcasting. The detected broadcasting station is not limited to one broadcasting station. Plural broadcasting stations may be detected. For the case where plural broadcasting stations are found, one of the broadcasting stations is selected in accordance with a criterion. As an example, a broadcasting station having a relatively good reception level or relatively good receiving quality may be selected. In any event, the information regarding the detected broadcasting station is stored in the AC signal information storage unit, and it is used for the subsequent intermittent reception of the AC signals.

When the AC signal is suitably received, the warning information determination unit 221 determines whether the received AC signal includes the warning information. For a case where no states of emergency caused by natural or man-made disasters occur, the warning information is not included in the AC signal.

When the AC signal includes the warning information, the providing information generating unit 223 generates providing information from the warning information. The providing information is to be provided to or output to the user. The providing information may be visually displayed by the display unit 209, or acoustically output by the speaker 211. The providing information may be output by both of them. Further, when the providing information is provided to the user, a vibrator may be activated to alert the user.

<<2.2 Example of Operations>>

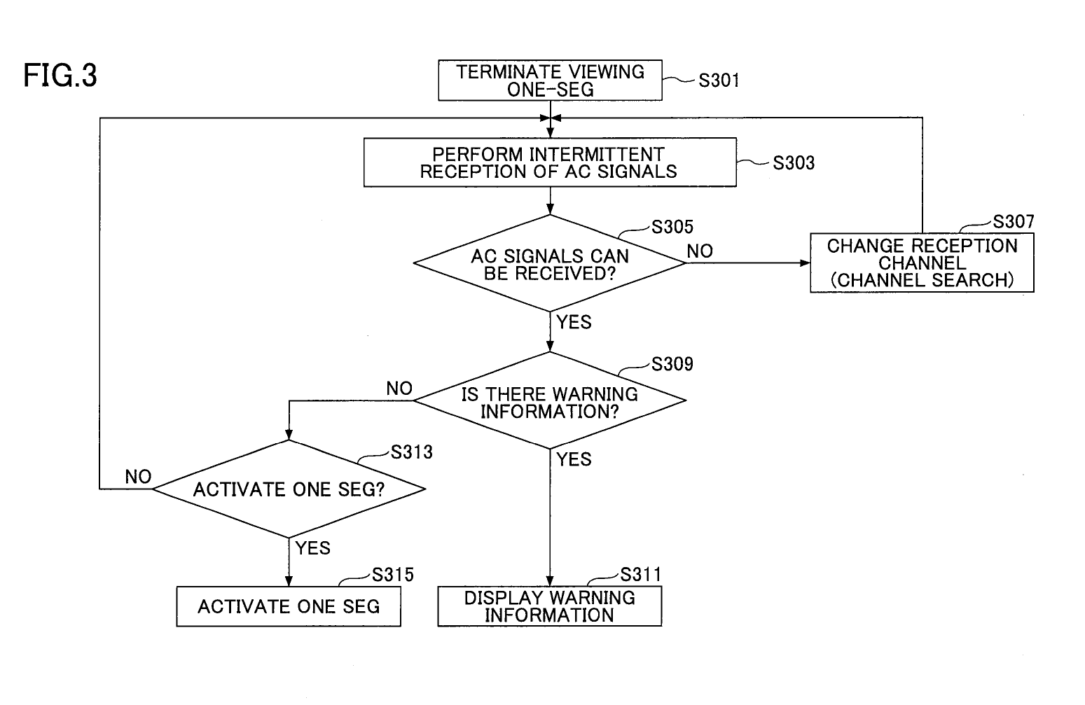

FIG. 3 shows an example of operations of the communication terminal according to the first embodiment shown in FIG. 2. As an assumption of the operations, the user of the communication terminal selects the first broadcasting station, and the user is viewing the signals for the one-segment broadcasting (one-segment signals). The first broadcasting station is the broadcasting station that does not perform the operation to include the warning information in the AC signal. Accordingly, as long as the one-segment signals from the first broadcasting station are received, the user may not receive the warning information when the state of emergency occurs.

At step S301, the user terminates viewing the one-segment signal from the first broadcasting station. Specifically, the user performs an operation to terminate viewing the One Seg broadcasting (e.g., an operation to turn off) by using the one-seg operations unit 207 or the display unit 209. The communication terminal stores information indicating that the user was viewing the program of the first broadcasting station. Such information may be stored as history information of viewing the program, or such information may be stored as information that only indicates the lastly selected channel.

At step S303, the communication terminal retrieves the AC signal by intermittently receiving the one-segment signals of the second broadcasting station. The second broadcasting station is the broadcasting station that performs the operation to include the warning information in the AC signal. Namely, at step S303, in response to the termination by the user of viewing (step S301), the communication terminal switches the turning frequency from the channel of the first broadcasting station to the channel of the second broadcasting station, and the communication terminal intermittently receives the one-segment signals from the second broadcasting station. The user may not recognize that the communication terminal switches the turning frequency and intermittently receives the one-segment signals from the second broadcasting station. The AC signal information storage unit 213 of FIG. 2 stores the information indicating which broadcasting station is performing the operation to include the warning information in the AC signal, during an emergency state. For a case where the broadcasting station which performs the operation to include the warning information in the AC signal is not found, the communication terminal intermittently receives the one-segment signals from the broadcasting station, where the user has just finished viewing the broadcasting station (in this case, the first broadcasting station). Accordingly, even if the user turns off the function to view the One Seg at step S301, the function of the communication terminal to intermittently receive the AC signals is not disabled, and the intermittent receiving of the AC signals is performed without being recognized by the user. However, it is not mandatory that the user does not recognize it. Some indications may be made, so that the user can find that the tuning frequency is switched and the one-segment signals are intermittently received from the second broadcasting station.

At step S305, the communication terminal determines whether the AC signal is suitably retrieved from the broadcasting station that performs the operation to include the warning information in the AC signal. This determination may be made based on any suitable criterion. As an example, when the AC signal is not received for greater than or equal to a constant time period, a determination may be made that the AC signal is not suitably retrieved from the broadcasting station that performs the operation to include the warning information in the AC signal. For example, when the user moves and the signal from the second broadcasting station may not be able to be received, the determination at step S305 becomes NO, and the flow proceeds to step S307. As described above, for the case where the broadcasting station that performs the operation to include the warning information in the AC signal is not detected at S303, the one-segment signals are intermittently received from the broadcasting station (which is the first broadcasting station, for this case), where the user has just finished viewing the broadcasting station.

In this case, since the suitable AC signal is not received, the determination at step S305 becomes NO, and the flow proceeds to step S307.

At step S307, the communication terminal finds a one-segment signal from the broadcasting station that performs the operation to include the warning information in the AC signal, among one-segment signals that can be received. Usually, in one reception area, there are plural broadcasting stations that broadcast the one-segment signals. Thus, there is a possibility that one or more broadcasting stations are found which perform such operations. It may not be found, but for such a case, the processes of steps S303, S305, and S307 are repeated. For the case where plural broadcasting stations are found, the communication terminal selects any one of the broadcasting stations based on a determination criterion. As an example, for a case where the broadcasting stations A, B, and C are found, the broadcasting station that transmits a one-segment signal whose reception level for the communication terminal is relatively strong (e.g., the broadcasting station A) may be selected. Alternatively, one broadcasting station (e.g., the broadcasting station B) may be randomly selected among plural broadcasting stations such that the corresponding reception levels are greater than or equal to a predetermined value, or a broadcasting station having a small identification number or a large identification number may be selected. From a perspective of reducing the labor to find the broadcasting station, the searching may be terminated at a time period where one broadcasting station is found which performs the operation to include the warning information in the AC signal. At any rate, one broadcasting station is identified, and the process returns to step S303, and the AC signals are intermittently received from that broadcasting station.

When a determination is made at step S305 that the AC signal is suitably received, the flow proceeds to step S309.

At step S309, the communication terminal determines whether the warning information is included in the intermittently received AC signals. For a case where a state of emergency such as an earthquake does not occur, such warning information is not included in the AC signal. For a case where a state of emergency such as the earthquake occurs, such warning information is included in the AC signal. When the warning information is included in the AC signal, the flow proceeds to step S311.

At step S311, the communication terminal outputs the received warning information to the user through the user interface. As an example, for a case where the warning information is an earthquake warning, information indicating an epicenter, a magnitude, seismic intensities of corresponding areas, and a possibility of tsunami is indicated on the display unit 209.

For a case where the intermittently received AC signals do not include any warning information at step S309, the flow proceeds to step S313.

At step S313, the communication terminal confirms whether the user performs the operation for viewing the One Seg. For a case where the user performs such an operation, the flow proceeds to step S315.

At step S315, the communication terminal activates the function for viewing the One Seg. In this case, the communication terminal returns the tuning frequency of the radio unit 201 to the channel of the broadcasting station, which is stored at step S301, and subsequently the communication terminal activates the function for viewing the One Seg. For example, subsequent to terminating viewing of the first broadcasting station at step S301, the AC signal of the second broadcasting station is monitored at step S303, and step S315 is reached through steps S305, S309, and S313. In this case, the communication terminal switches the tuning frequency to the channel of the first broadcasting station, the communication terminal receives the one-segment signals from the first broadcasting station, and the communication terminal enables viewing of the program through the display unit 209 and the speaker 211. In this manner, by returning the channel of the broadcasting station to the original state, the user can perform viewing without discomfort.

Whereas, when the operation for viewing the One Seg is not performed at step S313, the flow returns to step S303, and the intermittent reception of the AC signals is continuously performed. Subsequently, the already explained processes are performed.

According to this example of the operations, even if the user selects the first broadcasting station that does not perform the operation to include the warning information in the AC signal, after viewing it, the communication terminal automatically selects the second broadcasting station that performs such an operation, and the communication terminal monitors the AC signal. When the warning information is detected, it is quickly indicated to the user. In this manner, the likelihood of the user to miss the warning information can be significantly reduced.

<3. Second Embodiment>

<<3.1 Communication Terminal>>

In the first embodiment, the determination is made as to whether the AC signal is suitably received (the element 217 of FIG. 2 and step S305 of FIG. 3). When it is not suitably received, the searching for the channel is performed (the element 219 of FIGS. 2 and S307 of FIG. 3). However, the present invention is not limited to this embodiment. A second embodiment enables searching from another perspective.

For example, in an area R, the second broadcasting station is a broadcasting station that performs the operation to include the warning information in the AC signal, and in another area S, the third broadcasting station is a broadcasting station that does not perform such an operation. Suppose that the second and third broadcasting stations are using the same channel CH—X concurrently. The user can receive the AC signal including the warning information by intermittently receiving the one-segment signals from the second broadcasting station, provided that the user is served in the area R. However, when the user is served in the area S, the one-segment signals which are intermittently received through the channel CH-X are from the third broadcasting station, not from the second broadcasting station, and the AC signal including the warning information may not be received. The second embodiment addresses such a problem.

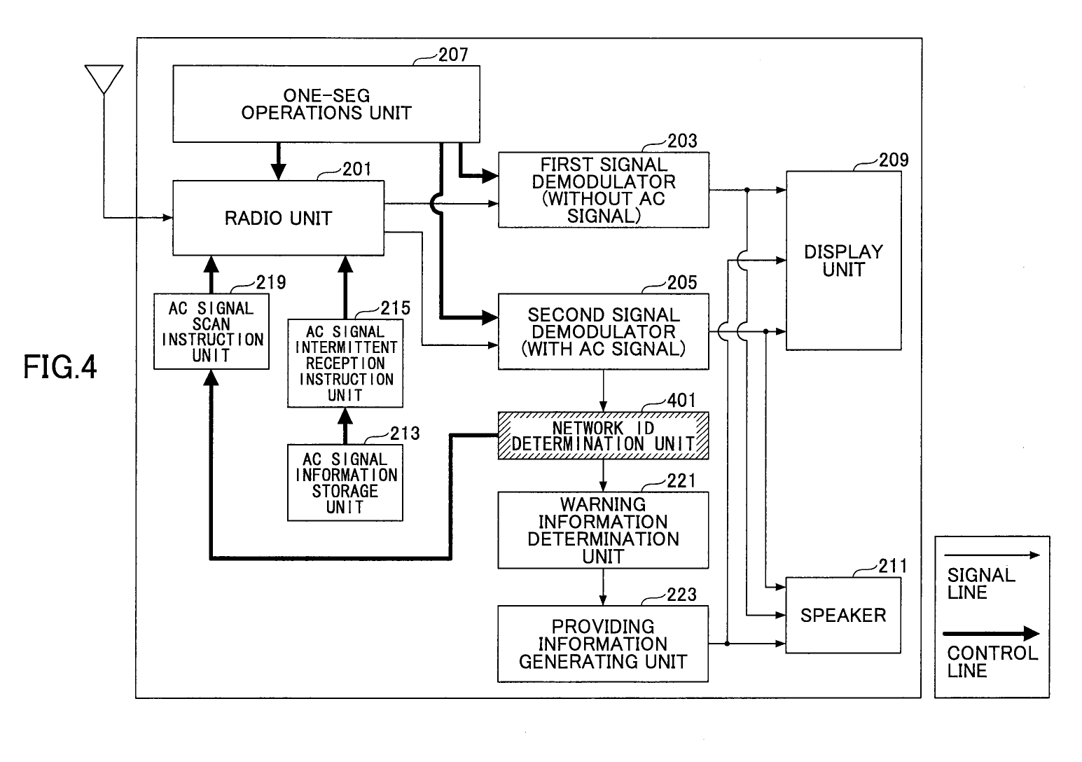

FIG. 4 shows a functional block diagram of the communication terminal which can be used in the second embodiment. The communication terminal can be used for the communication system such as shown in FIG. 1. The communication terminal is generally the same as that of shown in FIG. 3. However, the communication terminal is different in a point that, instead of the AC signal determination unit 217 of FIG. 3, a network ID determination unit 401 is included. However, it is not mandatory for the second embodiment that the AC signal determination unit 217 of FIG. 2 is not included. That is merely for simplifying the illustration. In addition to the AC signal determination unit 217 of FIG. 2, the network ID determination unit 401 of FIG. 4 may be included.

In general, when a broadcasting station transmits a one-segment signal, the one-segment signal includes an identifier (a network identifier or a network ID) which is unique to the broadcasting station. For the case of the above-described example, the one-segment signal which is received through the channel CH-X in the area R includes a network ID (ID-2) indicating the second broadcasting station. The one-segment signal received through the channel CH-X in the area S includes a network ID (ID-3) indicating the third broadcasting station. The network ID determination unit 401 monitors the network ID included in the received one-segment signal, and determines whether it is changed. When the network ID is changed, the receiving area is changed. Thus, the network ID determination unit 401 prompts the AC signal scan instruction unit to search for a channel.

<<3.2 Example of Operations>>

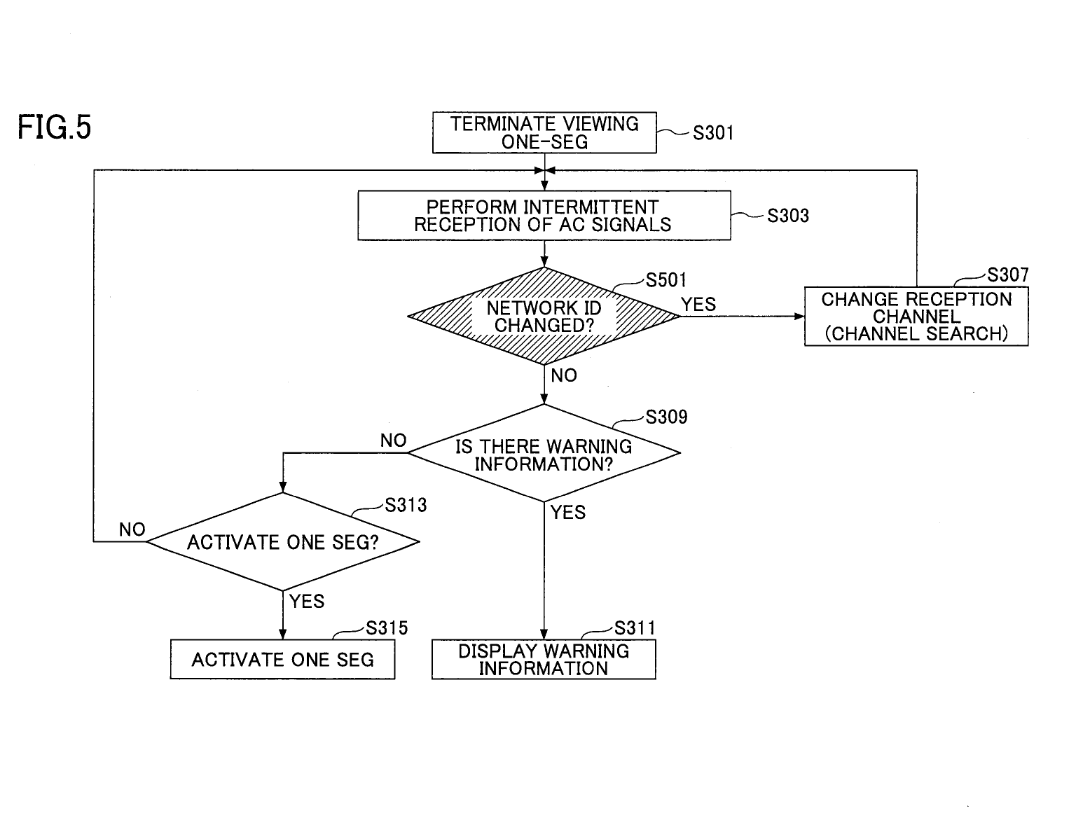

FIG. 5 shows an example of operations in the communication terminal of the second embodiment which is shown in FIG. 4. In general, it is the same as those of shown in FIG. 3. However, it is different mainly in a point that a process of step S501 is performed, instead of that of step S305. At step S501, the communication terminal monitors the network ID included in the received one-segment signal, and determines whether it is changed. When it is changed, the flow proceeds from step S501 to step S307, and searching for a channel is performed. In this manner, even if the receiving area is changed, a broadcasting station is found which performs the operation to include the warning information in the AC signal, and the AC signals can be suitably and continuously received from that broadcasting station.

Here, for simplicity of the explanation, in the flow of FIG. 5, the process of step S501 is performed, instead of the process of step S305 of

FIG. 3 of the first embodiment. However, it is not mandatory. Both the process of step S305 of FIG. 3 and the process of step S501 of step S501 may be performed. For the case where the both are performed, the flow may proceed to step S307 if the AC signal is not suitably received (S305) or if the network ID is changed (S501). Alternatively, the flow may proceed to step S307 only if the AC signal is not suitably received (S305) and the network ID is changed (S501).

<4. Third Embodiment>

<<4.1 Communication Terminal>>

In the second embodiment, the chance to perform the searching for the channel is determined by monitoring the change of the channel. However, the present invention is not limited to this embodiment. A third embodiment enables searching from another perspective.

The change of the receiving area where the user is served may be directly determined by location information of the user or the communication terminal. In the third embodiment, searching for a channel is performed from such a perspective.

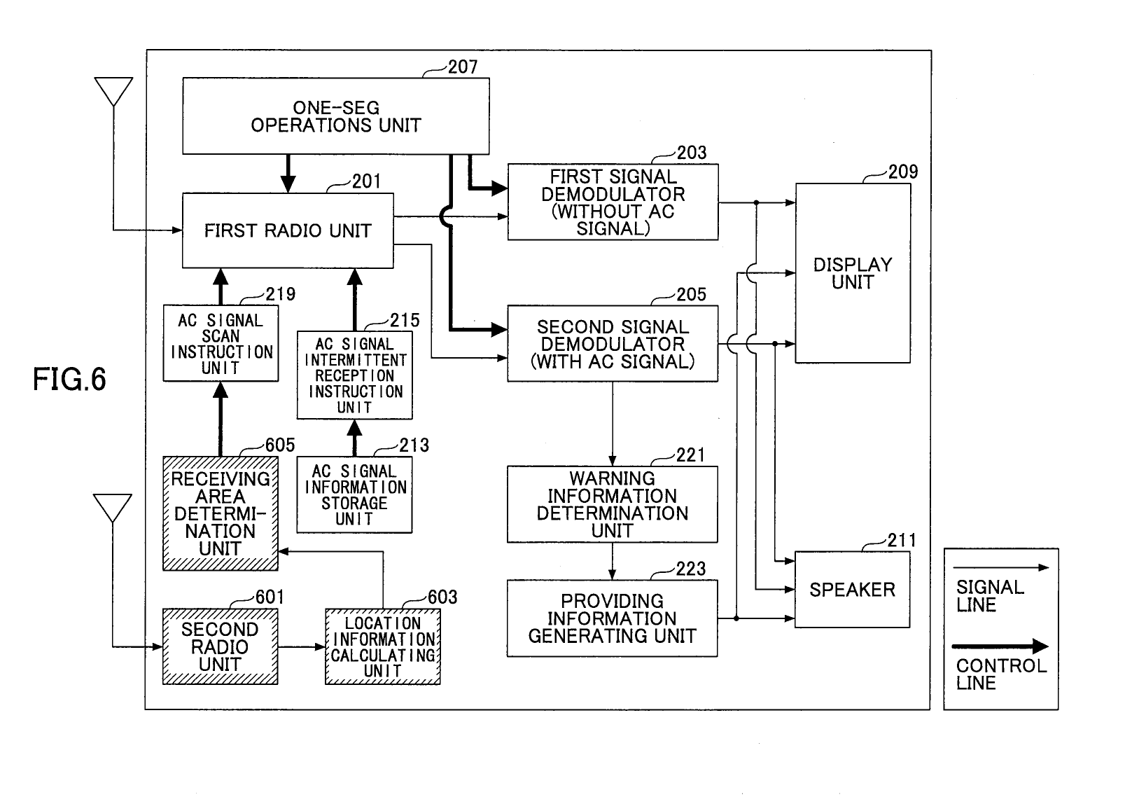

FIG. 6 shows a functional block diagram of the communication terminal that can be used in the third embodiment. This communication terminal can also be used for the communication system shown in FIG. 1. The communication terminal is generally the same as those of shown in FIGS. 3 and 5. However, it is different in a point that it includes a second radio unit 601; a location information calculating unit 603; and a receiving area determination unit 605, instead that the AC signal determination unit 217 of FIG. 2 and the network ID determination unit 401 are not included. However, it is not mandatory for the third embodiment that the AC signal determination unit 217 of FIG. 2 and the network ID determination unit 401 of FIG. 4 are not included. That is merely for simplifying the illustration. Both or one of the AC signal determination unit 217 and the network ID determination unit 401 may be additionally included.

The second radio unit 601 receives a radio signal for retrieving location information. Typically, such a radio signal includes signals received from satellites of the global positioning system (GPS). However, the signal is not limited to this. For example, a receiving area of television broadcasting is a wide area that extends to 100 km, while a cell of a mobile telephone is at an extent of several kilometers. Accordingly, the location of the cellular base station may substitute for the location of the user for determining the receiving area of the television broadcasting.

The location information calculating unit 603 retrieves the location information from the radio signal received by the second radio unit 601. For a case where the radio signal is the signals from satellites of the GPS, the location information is represented by a latitude and a longitude. For a case where the radio signal is that of obtained from the cellular base station, the location information is represented by the location of the cellular base station.

The receiving area determination unit 605 determines the receiving area of the television broadcasting where the user or the communication terminal is served, based on the location information calculated by the location information calculating unit 603. The determination of the receiving area may be made by indicating the current location of the user and the receiving area on a map. When a determination is made that the receiving area is changed, the receiving area determination unit 605 prompts the AC signal scan instruction unit 219 to search for a channel. When a determination is made that the receiving area is not changed, the receiving area determination unit 605 does not request the AC signal scan instruction unit 219 to search the channel.

<<4.2 Example of Operations>>

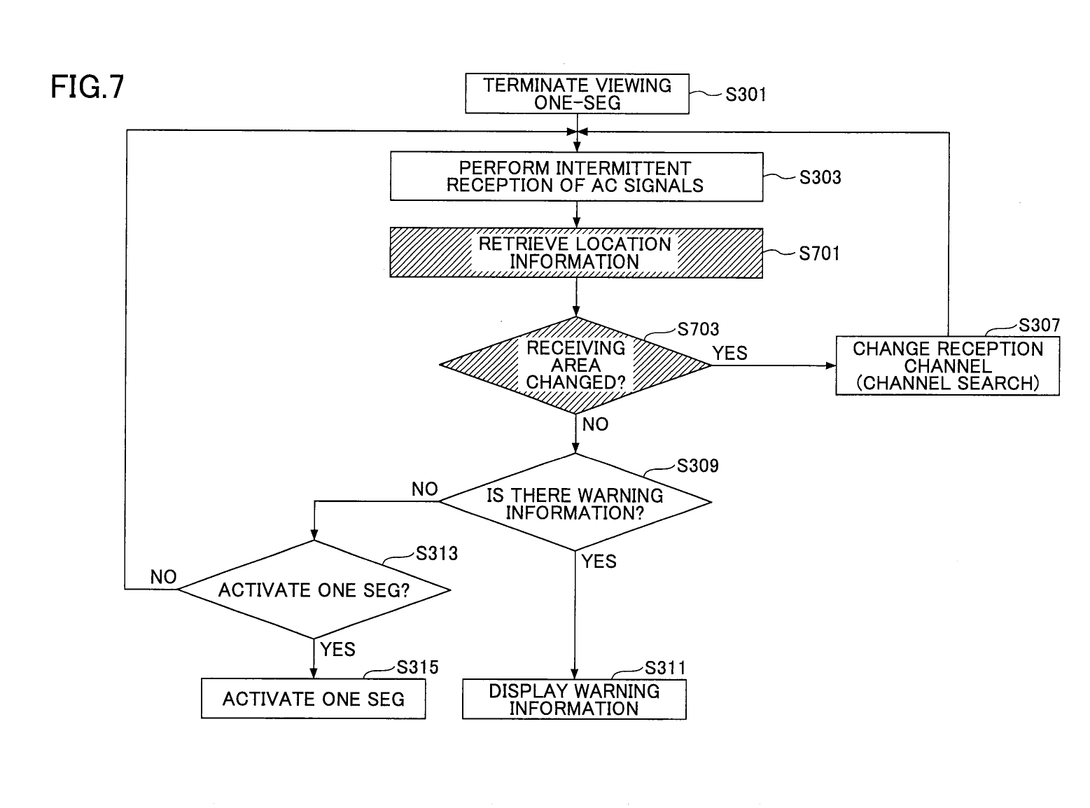

FIG. 7 shows an example of operations in the communication terminal in the third embodiment, which is shown in FIG. 6. In general, it is the same as the example of the operations shown in FIG. 3. However, it is different in a point that processes of steps S701 and S703 are performed instead of step S305. At step S701, the communication terminal retrieves the location information. At step S703, the communication terminal determines whether the receiving area of the television broadcasting is changed, based on the location information. When a determination is made that the receiving area is changed, the flow proceeds from step S703 to step S307. When a determination is made that the receiving area is not changed, the flow proceeds from step S703 to step S309.

In this manner, even if the receiving area is changed, a broadcasting station can be found which performs the operation to include the warning information in the AC signal, and the AC signals can be continuously and suitably received from the broadcasting station.

Here, the processes of steps S701 and S703 of the third embodiment may be performed without or concurrently with performing the process of step S305 of FIG. 3 of the first embodiment and the process of step S501 of FIG. 5 of the second embodiment. For example, after step S303, when (1) the AC signal is not suitably received, (2) the network ID is changed, or (3) the determination is made that the receiving area is changed based on the location information, the flow may proceed to step S307. Alternatively, after step S303, if the two among (1), (2), and (3) are satisfied, the flow may proceed to step S307.

Hereinabove, the present invention is explained by referring to the specific embodiments. However, the embodiments are merely illustrative, and variations, modifications, alterations and substitutions could be conceived by those skilled in the art. For example, the present invention may be applied to any suitable communication system that performs so-called “One Seg” services. Specific examples of numerical values are used in order to facilitate understanding of the invention. However, these numerical values are simply illustrative, and any other appropriate values may be used, except as indicated otherwise. The separations of the embodiments or the items are not essential to the present invention. Depending on necessity, subject matter described in two or more embodiments or items may be combined and used, and subject matter described in an item may be applied to subject matter described in another embodiment or item (provided that they do not contradict). The separations of the functional units or the processing units in the functional block diagrams do not always correspond to the boundaries of physical components. Operations of plural functional units may be physically performed by one component, or an operation of a single functional unit may be physically performed by plural components. For the convenience of explanation, the devices according to the embodiments of the present invention are explained by using functional block diagrams. However, these devices may be implemented in hardware, software, or combinations thereof. The software may be prepared in any appropriate storage medium, such as a random access memory (RAM), a flash memory, a read-only memory (ROM), an EPROM, an EEPROM, a register, a hard disk drive (HDD), a removable disk, a CD-ROM, a database, a server, and the like. The present invention is not limited to the above-described embodiments, and various variations, modifications, alterations, substitutions and so on are included, without departing from the spirit of the present invention.

The present application claims priority based on Japanese Patent Application No. 2011-153293, filed on Jul. 11, 2011, the entire contents of which are hereby incorporated by reference.

### LIST OF REFERENCE SYMBOLS

201: Radio unit

203: First signal demodulator

205: Second signal demodulator

207: One-seg operations unit

209: Display unit

211: Speaker

213: AC signal information storage unit

215: AC signal intermittent reception instruction unit

217: AC signal determination unit

219: AC signal scan instruction unit

221: Warning information determination unit

223: Providing information generating unit 223

401: Network ID determination unit

601: Second radio unit

603: Location information calculation unit

605: Receiving area determination unit

1. A communication terminal comprising:
a receiver that receives a one-segment signal from a broadcasting station among plural broadcasting stations that provide terrestrial digital broadcasting;
an output unit that outputs the one-segment signal received by the receiver to a user;
a channel search unit that searches for a specific broadcasting station that transmits the one-segment signal including an auxiliary information signal which is likely to include warning information, among the one-segment signals which are transmitted from the corresponding broadcasting stations; and
a determination unit that determines, subsequent to termination of viewing with respect to the broadcasting station which is selected by the user, whether the auxiliary information signal included in the one-segment signal received from the specific broadcasting station by the receiver includes the warning information,
wherein, when the auxiliary information signal includes the warning information, the output unit outputs the warning information to the user.

2. The communication terminal according to claim 1,
wherein, when the one-segment signal including the auxiliary information signal which is likely to include the warning information is not received for greater than or equal to a constant time period, the channel search unit searches for the specific broadcasting station that transmits the one-segment signal including the auxiliary information signal which is likely to include the warning information.

3. The communication terminal according to claim 1,
wherein, if a broadcasting station identifier of the one-segment signal received by the receiver is changed when the determination unit determines presence or absence of the warning information, the channel search unit searches for the specific broadcasting station.

4. The communication terminal according to claim 1, further comprising:
a location information retrieval unit that retrieves location information of the communication terminal,
wherein, when a receiving area of the one-segment signal, the communication terminal being served in the receiving area, is changed, the channel search unit searches for the specific broadcasting station.

5. The communication terminal according to claim 1,
wherein, when more than one of the broadcasting stations are found which transmit the one-segment signals including the auxiliary information signals which are likely to include the warning information, the channel search unit reports, as the specific broadcasting station, the broadcasting station being selected among the more than one of the broadcasting stations based on receiving quality to the determination unit.

6. The communication terminal according to claim 1,
wherein, when the single broadcasting station is found which transmits the one-segment signal including the auxiliary information signal which is likely to include the warning information, the channel search unit reports, as the specific broadcasting station, the single broadcasting station to the determination unit.

7. A warning information retrieval method comprising steps of:
receiving a one-segment signal from a broadcasting station among plural broadcasting stations that provide terrestrial digital broadcasting, and outputting the one-segment signal to a user;
subsequent to termination of viewing with respect to the broadcasting station which is selected by the user, searching for a specific broadcasting station that transmits the one-segment signal including an auxiliary information signal which is likely to include warning information, among the one-segment signals which are transmitted from the corresponding broadcasting stations; and
determining whether the auxiliary information signal included in the one-segment signal received from the specific broadcasting station includes the warning information, and
outputting the warning information to the user when the auxiliary information signal includes the warning information.
